(19) United States
(12) Patent Application Publication
(10) Pub. No.: US 2002/0005601 A1
(43) Pub. Date: Jan. 17, 2002

(54) Method for making plastic product containing barium strontium titanate for absorbing electromagnetic waves of low and intermediate frequencies

(76) Inventor: Ding Chung Liou, Miso Li (TW)

Correspondence Address: Raymond Yat Chiu Chan, 1050 Oak Dale Lane, Arcadia, CA, 91006, US

(21) Appl. No.: 09/729,159

(22) Filed: Dec. 4, 2000

(30) Foreign Application Priority Data
Jul. 9, 2000 (TW) 089118396

(51) Int. Cl. B29C 47/00

(52) U.S. Cl. 264/104; 264/143

(57) ABSTRACT

A method is designed to make a plastic product capable of absorbing electromagnetic waves. The method comprises a first step in which a Barium Strontium Titanate powder is formed of aqueous solutions of titanium oxalate, strontium oxalate, and barium oxalate. The Barium Strontium Titanate powder is then mixed with a plastic organic compound to form a mixture, which is heated at a temperature corresponding to the melting point of the plastic organic compound, thereby resulting in formation of a molten mixture. A plurality of strips are formed of the molten mixture by extrusion. The strips are cut into granular pieces capable of absorbing electromagnetic waves of low and intermediate frequencies.

### FIELD OF THE INVENTION

The present invention relates generally to a method for making a plastic product for use in electric appliances and electronic communication equipments, and more particularly to a method for making a plastic product containing the Barium Strontium Titanate for absorbing the electromagnetic waves emitted by the electric appliances or electronic communication equipments.

### BACKGROUND OF THE INVENTION

The electromagnetic waves are known to be the causes responsible for various disorders in central nervous system, immunity system and visual function of the human body. In addition, there are scientific evidences suggestive of the linkage between the cancer and the electromagnetic waves. As a result, the manufacturers of the electric appliances and the electronic communication equipments are required by governments of many nations to make the products in compliance with the strict regulations in connection with electronic and magnetic interference (EMI), electronic and magnetic susceptibility (EMS), electromagnetic compatibility (EC), electronic and magnetic compatibility (EMC), etc.

The plastic products are widely used by the electronic industry in making a variety of electronic products. For example, the housing of the electronic product is generally made of a plastic material. In order to meet the electromagnetic requirements described above, the makers of the electronic products strive to improve the quality of the housing of the electronic products. The improvement on the electronic housing is generally attained by adding various conductive materials to the plastic product of which the housing is made. The conductive materials include copper, nickel, zinc, and other heavy metals. The housing may be provided with a metal plate or wire to reflect the electromagnetic wave. Such conventional methods as described above are not cost-effective at best. In addition, the adding of the heavy metals increase to complicates the production process of the plastic housing. Moreover, the folded or curved portions of the housing are susceptible to leak of electromagnetic waves. The plastic product containing the heavy metals can not be easily recycled. In light of these factors described above, the plastic products containing the heavy metals are prohibited as far as the electronic and magnetic compatibility (EMC) test standards are concered. For more details, please refer to TCO'99 Certification, Requirements and Test Methods for Enviromental Labelling of Ecology, for Displays, System Units and Keyboards. Report No. 5: Metallization of plastic Housings.

The plastic housings containing barium titanate are technically deficient. For example, the particles of barium titanate are not uniformly distributed in the plastic housings in view of the fact the diameter of the barium titanate particle is as small as 100 microns, and that the specific gravity of the barium titanate particle is 6. For more details, please refer to THE MERCK INDEX or the internet of Atlantic Equipment Engineer Company. The diameter of the plastic material particle is about 3.5 mm, with its specific gravity being one. For this reason, when the plastic material particles and the barium titanate particles are mixed together, the barium titanate particles tend to quick fall down the bottom of the container in which the plastic material particles and the barium titanate particles are mixed, As a result, those plastic housings which are formed in the early stage of injection molding tend to contain an excessive amount of barium titanate. On the contrary, those plastic housings which are formed in the late stage of injection molding tend to contain an insufficient amount of barium titanate, thereby undermining the effectiveness of the plastic housings in absorbing the electromagnetic waves.

In order to be effective in the absorption of electromagnetic waves, the volume ratio of the plastic housings containing barium titanate must range between 15% and 60%. Accordingly, the weight percentage of barium tianate of the plastic housing must range between 52% and 90% in view of the fact that the specific gravity of barium titanate is 6, and that the specific gravity of the plastic material is one. In light of the high cost of barium titanate, the plastic housings containing barium titanate are not cost-effective. For this reason, barium titanate is not commonly used by the industry as an agent to absorb the electromagnetic waves. Finally, the plastic housings containing barium titanate are relatively heavy and are therefore limited in its application in the electronic industry.

### SUMMARY OF THE INVENTION

The primary objective of the present invention is to provide a method for making a plastic housing which contains Barium Strontium Titanate for absorbing electromagnetic waves of low and intermediate frequencies, The method of the present invention involves a first step in which an appropriate amount of a plastic material and appropiate amount of the powdered Barium Strontium Titanate are mixed together to form a mixture, which is then heated at a temperature corresponding to a melting point of the plastic material. The molten mixture is subsequently formed into strips by extrusion. The strips are cut into granules, which are added to the compatible plastic material to form the plastic housing capable of absorbing the electromagnetic waves emitted by a device contained in the plastic housing. The plastic housing of the present invention is also capable of minimizing the external electromagnetic interference, thereby resulting in enhancement of the electromagnetic susceptibility of an electrical or electronic product.

In light of excellent spontaneous electric polarization of the Barium Strontium Titanate, the method of the present invention is capable of making a plastic product which is 99% effective in absorbing the electromagnetic waves of low and intermediate frequencies in spite of only a small amount of the Barium Strontium Titanate that are contained in the plastic product. In addition, the plastic product made by the method of the present invention is relatively light in weight and is therefore suitable for use in making a compact or miniaturized device.

The plastic product made by the method of the present invention is recyclable in view of the fact that the Barium Strontium Titanate is inert in nature, and not metallic in nature. For this reason, the plastic product made by the method of the present invention is not hazardous to human health.

In the conventional process for making a plastic product by injection molding, an appropriate amount of calcium carbonate is added as a filler. In the method of the present invention, the Barium Strontium Titanate serve as fillers, thereby resulting in reduction in the material cost.

### BRIEF DESCRIPTION OF THE DRAWINGS

FIG. 1 shows a process block diagram of the method of the present invention.

FIG. 2 shows a schematic view of Barium Strontium Titanate of the present invention being acted on by an electric field effect.

FIG. 3 shows another schematic view of Barium Strontium Titanate of the present invention being acted on by an electric field effect.

### DETAILED DESCRIPTION OF THE INVENTION

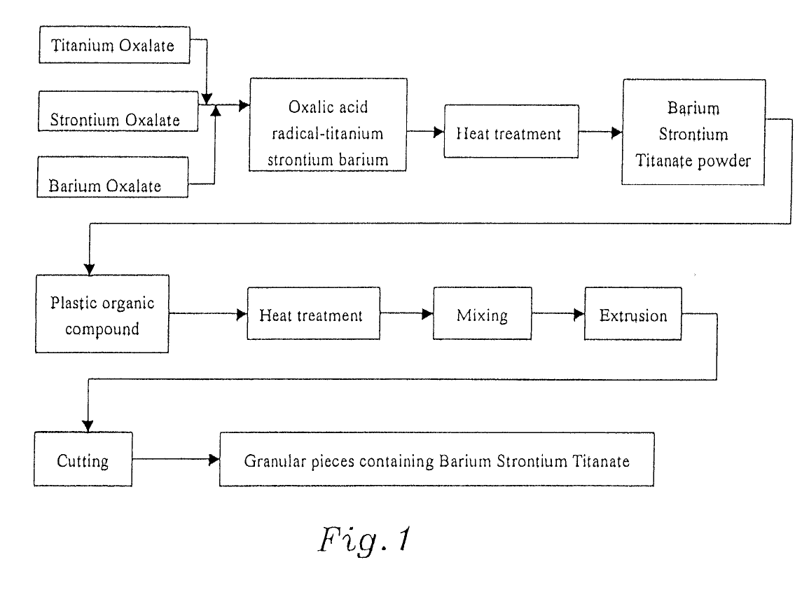

As shown in FIG. 1, a method of the present invention is designed to make a plastic product containing Barium Strontium Titanate for absorbing electromagnetic waves of low and intermediate frequencies.

The method of the present invention comprises a first step in which the aqueous solutions of titanium oxalate 11, strontium oxalate 12, and barium oxalate 13 are mixed together to form an oxalic acid compound 10 with a chemical formula being Ba₍₁₋ₓ₎SrₓTiO₃, in which X is between 0 and 1. The oxalic acid compound 10 is heated at temperature 800° C. to become a Barium Strontium Titanate powder 20, which is then mixed with a plastic organic compound 30 to form a mixture. The mixture is heated at a temperature corresponding to the melting point of the plastic organic compound 30, thereby resulting in the formation of a molten mixture 30′. The molten mixture 30′ is formed into strips by extrusion. The strips are cut into granules 40 capable of absorbing electromagnetic waves of low and intermediate frequencies.

The Barium Strontium Titanate powder 20 is formed of particles with a diameter ranging between 0.5 μm and 30 μm. The mixture contains the Barium Strontium Titanate powder 20 and the plastic organic compound 30 in the weight ratio of 1:1.

In addition, these granules 40 are almost equal with the compatible plastic material in sizes, when these granules 40 are then injected into the compatible plastic material, these granules 40 can uniform mixed feed with the compatible plastic material, and render the granules 40 are not fall down the bottom of the container. The Barium Strontium Titanate powder 20 of the granules 40 are to make uniform distribute into the production process of the plastic housing, and enable the Barium Strontium Titanate powder 20 to make uniform distribute into the plastic housing.

The plastic organic compound 30 of the method of the present invention may be polytetrafluoroethylene, polyvinylalcohol, polyethylene, polyvinyl chloride, polypropylene, acronitrile-butadine-styrene, polycarbonate, or polycarbonate/acronitrile-butadine-styrene.

The Barium Strontium Titanate powder 20 absorbs electromagnetic waves; it does not reflect electromagnetic waves. For this reason, the particle size is not taken into consideration in the present invention. In addition, the Barium Strontium Titanate powder 20 and the plastic organic compound 30 are compatible and chemically stable. The Barium Strontium Titanate power 20 can serve as a filler. In other words, the method of the present invention does not call for the use of a filter, thereby resulting in reduction in the material cost. The Barium Strontium Titanate powder 20 of the method of the present invention is an inert material, not a metallic material. As result, the plastic product made by the method of the present invention is not harmful to the human health.

The optimal weight ratio of the plastic organic compound 30 and the Barium Strontium Titanate powder 20 of the method of the present invention ranges between 0.5% and 15%. Such a plastic product is capable of absorbing 99% or more of electromagnetic waves under 1000 MHZ. In light of the specific gravity of the Barium Strontium Titanate powder 20 being 5.8, the volume of the Barium Strontium Titanate powder 20 ranges between 0.0008 and 0.03 relative to the total volume of the plastic product. This implies that the method of the present invention makes use of a small amount of the compound 10 to achieve the goal. As a result, the method of the present invention is cost-effective.

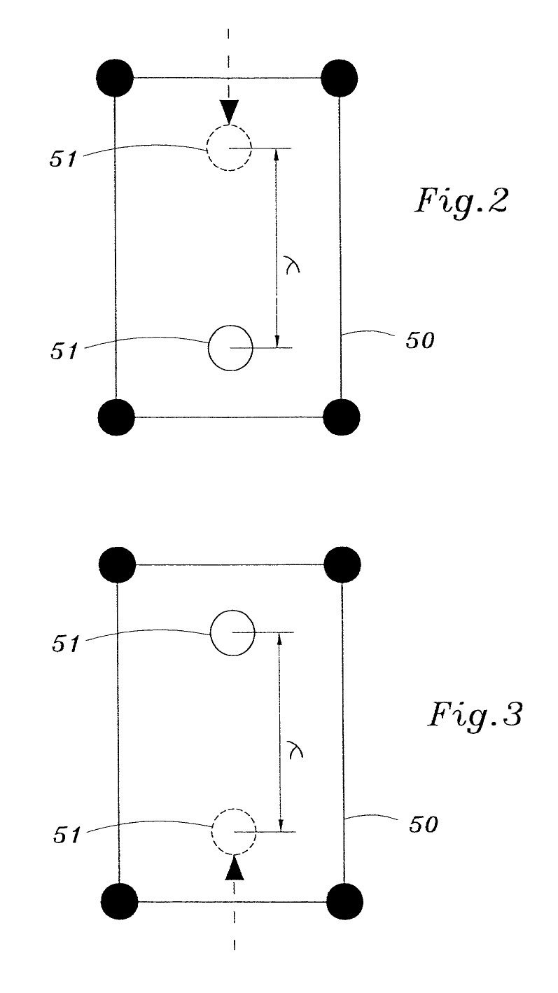

As shown in FIGS. 2 and 3, in the crystal lattice 50 of the Barium Strontium Titanate powder 20 of the present invention, the strontium atom and the barium atom differ in size from each other. Please refer to “Principles of Electronic Ceramics”, Chapter 1.4, Table 1.2, by L. L. Hencb and J. K. West. The radii of Ba⁺² and Sr⁺² are respectively 1.35 Å and 1.16 Å. The titanium atom 51 in the crystal lattice 50 is located at an asymmetric position. When the plastic product containing the Barium Strontium Titanate powder 20 of the present invention is under the electromagnetic interference, the Barium Strontium Titanate powder 20 of the present invention is acted on by the electric field effect of the electromagnetic wave, thereby causing the titanium atom 51 in the crystal lattice 50 of the Barium Strontium Titanate powder 20 to jump an appropriate displacement λ, as shown in FIGS. 2 and 3. In the process of the electromagnetic wave interference, the direction of the electric field keeps changing alternately at 180 degrees, shown by the imaginary lines and arrows in FIGS. 2 and 3. In the meantime, the titanium atom 51 jumps back and forth in the crystal lattice 50 along with the change in direction of the electric field. According to the principle of energy conservation, the work that is needed and the heat that is produced in the jump process of the titanium atom 51 are all derived from the electric field energy of the electric field. As a result, energy of the electric field is partially consumed each time when the titanium atom 51 jumps. If the plastic product contains 5% by weight of the Barium Strontium Titanate powder 20, an area of one square centimeter of the plastic product contains millions of crystal lattices 50 of the Barium Strontium Titanate powder 20. When a plastic component part or a plastic housing is encountered with an electromagnetic interference, millions of the crystal lattices 50 absorb continually the energy of the electromagnetic wave. The energy so absorbed is then converted into work or heat. As the energy of the electric field diminishes, the magnetic field intensity of the electromagnetic wave weakens gradually to minimize the effect or interference of the electromagnetic wave.

A test sample containing 5% by weight of the Barium Strontium Titanate additive was made by this inventor of the present invention. The test sample was used by Taiwan Industrial Technology Research Institute for the study on the blocking effect of the additive on the electromagnetic waves, as shown in the attachment. The test instrument used in the test was a coaxial transmission line. The test equipments included Witlon 6745B signal generator, HP 8566 spectrometer, HP 8491B 10 dB disintegrator, and a subject clamping tool made by W.E. Measurement Co.

The block diagram of the above test system is shown as follows:

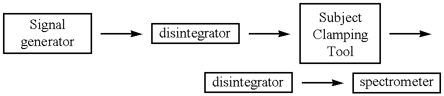

As far as the definition of the blocking effect is concerned, the output power of the signal generator remains constant. The power of the electromagnetic blocking material held by the clamping tool is P1 , which is measured by the spectrometer. The power of the nonelectromagnetic blocking material held by the clamping tool is P2 . The formulary for computing the ratio is as follows:

The blocking effect dB=−10 log [P1 (power of test sample containing Barium Strontium Titanate)/P2 (power of an ordinary plastic test sample containing no Barium Strontium Titanate]

As shown in the attached test results, the blocking effect of the test sample is 22.20 dB at 30 MHZ; 23.60 dB at 100 MHZ; 21.80 dB at 300 MHZ; 24.80 dB AT 500 MHZ; and 26.30 dB AT 1000 MHZ. The datum of 22.20 dB is introduced to the above formulary to compute the ratio value of P1 and P2 , which is 0.006026. On the basis of the difference between P1 and P2 , the electromagnetic wave blocking rate [(1−P1/P2 )*100%] of the present invention is greater than 99.04% at 30 MHZ; 99.56% at 100 MHZ; 99.34% at 300 MHZ; 99.67% at 500 MHZ; and 99.77% at 1000 MHZ. It is therefore apparent that the plastic product of the present invention containing only 5% by weight of the powder 20 is capable of asorbing up to 99% of the electromagnetic waves under 1000 MHZ.

What is claimed is:

1. A method for making a plastic product capable of absorbing electromagnetic waves of low and intermediate frequencies, said method comprising the steps of:
(a) mixing aqueous solutions of titanium oxalate, strontium oxalate, and barium oxalate to form an oxalic acid radical-titanium strontium barium, which is heated to become a Barium Strontium Titanate powder;
(b) mixing an appropriate amount of the Barium Strontium Titanate powder with an appropriate amount of a plastic organic compound to form a mixture, which is heated at a temperature corresponding to the melting point of the plastic organic compound, thereby resulting in formation of a molten mixture; and
(c) forming the molten mixture into a plurality of strips by extrusion whereby said strips are cut into granular pieces capable of absorbing electromagnetic waves of low and intermediate frequencies.

2. The method as recited in claim 1, wherein said Barium Strontium Titanate powder of the step (a) has a chemical formula of Ba₍₁₋ₓ₎SrₓTiO₃, with X of the chemical formula being between 0 and 1.

3. The method as recited in claim 1, wherein said Barium Strontium Titanate powder and said plastic organic compound are mixed in weight ratio of 1:1 in the step (b).

4. The method as recited in claim 1, wherein said plastic organic compound of the step (b) is polytetrafluoroethylene, polyvinyl alcohol, polyethylene, polyvinyl chloride, polypropylene, acronitrile-butadine-styrene, polycarbonate, or polycarbonate/acronitrile-butadine-styrene.
